(19) United States
(12) Patent Application Publication
(10) Pub. No.: US 2007/0294012 A1
(43) Pub. Date: Dec. 20, 2007

(54) VEHICLE SAFETY SYSTEM

(75) Inventor: GA-LANE CHEN, Santa Clara, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/559,836

(22) Filed: Nov. 14, 2006

(30) Foreign Application Priority Data
Jun. 16, 2006 (CN) 200610061182.9

(51) Int. Cl. B60R 22/00; G06F 17/00

(52) U.S. Cl. 701/45

(57) ABSTRACT

A vehicle safety system (10) includes a camera device (100) configured for capturing video information of eyes of a driver, and a processing system (200). The processing system includes a monitor unit (210) configured for monitoring eye-closure duration of the driver based on the video information of the eyes of the driver, and an alarm unit (220) configured for alerting the driver if the eye-closure duration exceeds a predetermined time limit. The vehicle safety system uses the alarm unit to prevent the driver from closing his/her eyes for too long, thereby decreasing the likelihood of a traffic accident.

### BACKGROUND OF THE INVENTION

1. Field of the Invention

The present invention relates to vehicle safety systems and, more particularly, to a vehicle safety system for monitoring eye-closure duration of a driver.

2. Description of Related Art

In modern society, automobiles are more and more popular as important transportation tools. However, traffic accidents are increasing along with the development of automobiles. In addition to human factors such as drink driving or speeding, main reasons for traffic accidents are generally associated with objective factors including poor visibility, and blind spots.

A typical safety device for mounting on an automobile includes a number of signal transmitters and receivers mounted in the automobile. When the automobiles equipped with the safety devices meet each other, they can transmit and receive signals to and from each other so as to inform drivers to avoid a traffic accident. However, the safety devices inform drivers only if all automobiles are so equipped. If the automobiles meet an automobile not equipped with the safety device, the safety device cannot inform the drivers.

Another typical safety device for an automobile includes a miniature camera configured for monitoring a blind zone of the driver and showing the images to the driver via a display screen.

However, vision is an important factor in obtaining information, and 80% of information in driving is obtained visually. Therefore, the state of eyes of a driver is closely related to safe driving. In conventional conditions, blinking involves eye-closure of a duration in an approximate range from 0.12 to 0.13 seconds. If eyes closure duration exceeds 0.15 seconds, the risk of a traffic accident occurring is greatly increased Neither of the above safety devices can prevent the driver from closing his/her eyes for too long.

What is needed, therefore, is a vehicle safety system for preventing a driver from closing his/her eyes for too long.

### SUMMARY OF THE INVENTION

A vehicle safety system for mounting on a vehicle according to one preferred embodiment includes a camera device configured for capturing video information of the eyes of a driver, and a processing system. The processing system includes a monitor unit configured for monitoring eye-closure duration of the driver based on the video information of the eyes of the driver, and an alarm unit configured for alerting the driver if the eye-closure duration of the driver exceeds a predetermined time limit.

The vehicle safety system uses the camera device to capture the video information of the eyes of the driver in time and the monitor unit to monitor the eye-closure duration of the driver. If the eye-closure duration exceeds the predetermined time limit, the alarm unit will alert the driver. Thus the driver is prevented from dozing or closing his/her eyes too long during driving, thereby decreasing the likelihood of a traffic accident. This vehicle safety system is small and occupies little space, so that it has little effect on the vehicle.

Other advantages and novel features will become more apparent from the following detailed description of present vehicle safety system, when taken in conjunction with the accompanying drawings.

### BRIEF DESCRIPTION OF THE DRAWINGS

Many aspects of the present vehicle safety system for mounting on a vehicle can be better understood with reference to the following drawings. The components in the drawings are not necessarily drawn to scale, the emphasis instead being placed upon clearly illustrating the principles of the present vehicle safety system. Moreover, in the drawings, like reference numerals designate corresponding parts throughout the several views.

FIG. 1 is a schematic view of a vehicle safety system for mounting on a vehicle in accordance with a preferred embodiment; and

FIG. 2 is a schematic view of a camera device used in the vehicle safety system of FIG. 1.

### DETAILED DESCRIPTION OF THE INVENTION

Reference will now be made to the drawings to describe a preferred embodiment of the present vehicle safety system for mounting on a vehicle in detail.

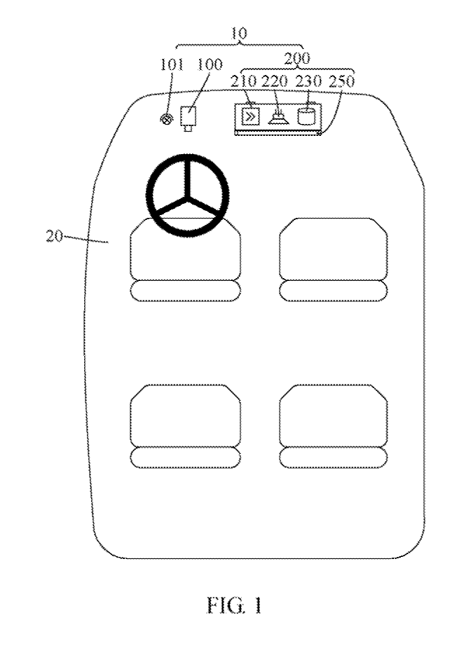

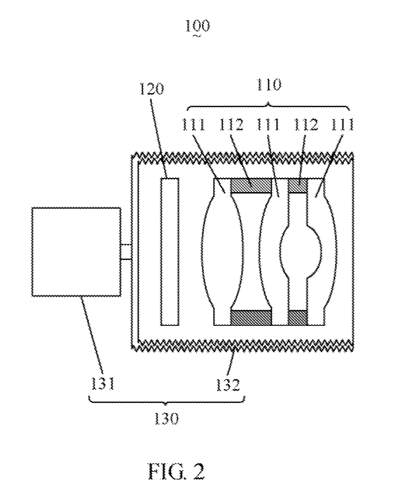

Referring to FIGS. 1 and 2, a vehicle safety system 10 for mounting on a vehicle 20 in accordance with a preferred embodiment, includes a camera device 100 configured for capturing video information of eyes of a driver, and a processing system 200 configured for receiving and processing the video information. The processing system 200 may be a computer system. The processing unit 200 includes a monitor unit 210 and an alarm 220 in electronic communication with the monitor unit 210. The monitor unit 210 is configured for monitoring eye-closure duration of the driver based on video information of the eyes of the driver transmitted from the camera device 100. The alarm 220 is configured for alerting the driver if the eye-closure duration of the driver exceeds a predetermined time limit.

The camera device 110 is a zoomable auto-focus camera arranged in front of the driver. The camera device 110 includes an optical module 110, an image pickup module 120 and a driving module 130. The optical module 110 is a module including plurality of aspheric lenses 111. In this exemplary embodiment, the optical module 110 includes three aspheric lenses 111 and two spacers 112 arranged between every two adjacent lenses 111. The optical module 110 may includes more aspheric lenses 111 to obtain a higher resolving power and zoom ability.

The image pickup module 120 is a kind of semiconductor device, such as a charge coupled device (CCD) or a complementary metal oxide semiconductor (CMOS). The resolving power of the image pickup module 120 can be in a range from 1.3 million pixels to 6 million pixels. The image pickup module 120 can be made by a chip on board method (COB) or a chip scale package method (CSP). In this exemplary embodiment, the image pickup module 120 is a charge coupled device (CCD).

The driving module 130 includes an actuator 131 and a telescopic barrel 132 mounted on the actuator 131. The actuator 131 may be a step motor, a voice coil motor, or a microelectromechanical motor. The actuator 131 is configured for extending or shrinking the telescopic barrel 132 to perform the zoom and auto-focus functions. In this exemplary embodiment, the actuator 131 is a microelectromechanical motor.

In this exemplary embodiment, the camera device 100 is arranged in front of the driver so that the camera device 100 can capture video information of the eyes of the driver. The video information is then transmitted to the processing system 200. The monitor unit 210 monitors the eye-closure duration of the driver based on the video information of the eyes of the driver. If the monitor unit 210 determines that the eye-closure duration has exceeded the predetermined time limit, the alarm 220 in electronic communication with the monitor unit 210 alerts the driver. The monitor unit 210 may be a computer system, which can determine the eye-closure duration of the driver based on the video information of the eyes of the driver. In this exemplary embodiment, the predetermined time limit is about 0.15 seconds.

Preferably, the vehicle safety system 10 further includes a light source 101 configured for illuminating the eyes of the driver. The light source 101 may be a visible light source or an infrared light source. In this exemplary embodiment, the light source 101 is an infrared light emitting diode having a wavelength in an approximate range from 700 nanometers to 1500 nanometers, thus allowing the camera device 100 to capture clear video information of the eyes of the driver in poor light conditions without distracting the driver.

The processing system 200 should preferably include a storage device 230 and a display device 250. The storage device 230 is configured for storing the video information of the eyes of the driver. The storage device 230 can be selected from a group consisting of hard disks, compact discs and mobile storage devices. The display device 250 should be configured for displaying the video information of the eyes of the driver. The display device 250 may be a liquid crystal display or a cathode ray tube display. In this exemplary embodiment, the store device 230 is a hard disk having a capacity in a range from 100 gigabytes to 1000 gigabytes. The display device is a TFT (thin film transistor) liquid crystal display.

Compared with the conventional vehicle safety system, the present vehicle safety system 10 has following advantages. The present vehicle safety system 10 uses the camera device 100 to capture the video information from the eyes of the driver in time and the monitor unit 210 to monitor the eye-closure duration of the driver based on the video information of the eyes of the driver. If the eye-closure duration exceeds the predetermined time limit, the alarm 220 will remain activated until the driver opens his/her eyes. Thus the driver is prevented from dozing or closing his/her eyes too long whilst driving by alarm 220 of the vehicle safety system 10, thereby decreasing the likelihood of a traffic accident. Furthermore, the vehicle safety system is small and only occupies a small volume, so that it has little effect on the automobile.

It is to be understood that the above-described embodiment is intended to illustrate rather than limit the invention. Variations may be made to the embodiment without departing from the spirit of the invention as claimed. The above-described embodiments are intended to illustrate the scope of the invention and not restricted to the scope of the invention.

What is claimed is:

1. A vehicle safety system for mounting on a vehicle, comprising:
a camera device configured for capturing video information of eyes of a driver; and
a processing system comprising
a monitor unit configured for monitoring eye-closure duration of the driver based on the video information of the eyes of the driver, and
an alarm unit configured for alerting the driver if the eye-closure duration of the driver exceeds a predetermined time limit.

2. The vehicle safety system as claimed in claim 1, wherein the camera device is a zoomable auto-focus camera arranged in front of the driver.

3. The vehicle safety system as claimed in claim 2, wherein the camera device includes an optical module, an image pickup module and a driving module.

4. The vehicle safety system as claimed in claim 3, wherein the optical module includes a plurality of aspheric lenses.

5. The vehicle safety system as claimed in claim 3, wherein the image pickup module is selected from a group consisting of charge coupled device and complementary metal oxide semiconductor.

6. The vehicle safety system as claimed in claim 5, wherein the image pickup module has a resolving power in an approximate range from 1.3 million pixels to 6 million pixels.

7. The vehicle safety system as claimed in claim 3, wherein the driving module comprises an actuator and a telescopic barrel.

8. The vehicle safety system as claimed in claim 7, wherein the actuator is selected from a group consisting of step motor, voice coil motor and microelectromechanical motor.

9. The vehicle safety system as claimed in claim 1, wherein the processing system is a computer system.

10. The vehicle safety system as claimed in claim 1, wherein the predetermined time is about 0.15 seconds.

11. The vehicle safety system as claimed in claim 1, further comprising a light source arranged in front of the driver, the light source being configured for illuminating the eyes of the driver.

12. The vehicle safety system as claimed in claim 11, wherein the light source is selected from a group consisting of visible light source and infrared light source.

13. The vehicle safety system as claimed in claim 12, wherein the light source is an infrared light emitting diode emitting light with a wavelength in an approximate range from 700 nanometers to 1500 nanometers.

14. The vehicle safety system as claimed in claim 1, wherein the processing system further comprises a storage device configured for storing the video information of the eyes of the driver.

15. The vehicle safety system as claimed in claim 14, wherein the storage device is selected from a group consisting of hard disks, compact discs and mobile storage devices.

16. The vehicle safety system as claimed in claim 14, wherein the processing system further comprises a display device configured for displaying the video information of the eyes of the driver.

17. The vehicle safety system as claimed in claim 16, wherein the display device is selected from a group consisting of liquid crystal display and cathode ray tube display.
